(19) United States
(12) Patent Application Publication
(10) Pub. No.: US 2013/0094804 A1
(43) Pub. Date: Apr. 18, 2013

(54) OPTICAL SWITCH

(71) Applicants: Long Chen, North Brunswick, NJ (US); Christopher R. Doerr, Middletown, NJ (US)

(72) Inventors: Long Chen, North Brunswick, NJ (US); Christopher R. Doerr, Middletown, NJ (US)

(73) Assignee: Alcatel-Lucent, USA Inc., Murray Hill, NJ (US)

(21) Appl. No.: 13/272,873

(22) Filed: Oct. 13, 2011

(51) Int. Cl. G02B 6/26

(52) U.S. Cl. 385/17; 264/1.25

(57) ABSTRACT

An apparatus, comprising an optical switch having Nᵢₙ optical input ports and Nₒᵤₜ optical output ports. The optical switch includes an input array of 1×Nₒᵤₜ optical switches, an output array of Nᵢₙ×1 optical switches and a plurality of optical crossconnect zones located in-between the input array and the output array. Nᵢₙ and Nₒᵤₜ are integers greater than 1, and, each of Nᵢₙ*Nₒᵤₜ output waveguide arms of the 1×Nₒᵤₜ optical switches are optically coupled to a corresponding one of Nᵢₙ*Nₒᵤₜ input waveguide arms of the Nᵢₙ×1 optical switches comprising an optical switch.

### TECHNICAL FIELD OF THE INVENTION

The present invention is directed, in general, to an optical device and methods for manufacturing and using the same.

### BACKGROUND

This section introduces aspects that may be helpful to facilitating a better understanding of the inventions. Accordingly, the statements of this section are to be read in this light and are not to be understood as admissions about what is in the prior art or what is not in the prior art.

Optical switches, such as photonic switches, are an important component in optical telecommunication systems. For instance, some optical switches enable signals in optical fibers or integrated optical circuits to be selectively switched from one circuit to another without the need to convert the optical signal to an electrical signal.

### SUMMARY

One embodiment includes an apparatus, comprising an optical switch having Nᵢₙ optical input ports and Nₒᵤₜ optical output ports. The optical switch includes an input array of 1×Nₒᵤₜ optical switches, an output array of Nᵢₙ×1 optical switches and a plurality of optical crossconnect zones located in-between the input array and the output array. Nᵢₙ and Nₒᵤₜ are integers greater than 1, and, each of Nᵢₙ*Nₒᵤₜ output waveguide arms of the 1×Nₒᵤₜ optical switches are optically coupled to a corresponding one of Nᵢₙ*Nₒᵤₜ input waveguide arms of the Nᵢₙ×1 optical switches.

In some embodiments, each 1×Nₒᵤₜ optical switch of the input array includes multiple levels of 1×K optical switches connected in a tree-like configuration. In some embodiments, wherein the 1×K optical switches are 1×2 type optical switches. In some embodiments, the 1×K optical switches are 1×4 type optical switches. In some embodiments, each Nᵢₙ×1 optical switch of the output array includes multiple levels of K×1 optical switches arranged in a tree-like configuration. In some embodiments, the K×1 optical switches are 2×1 type optical switches. In some embodiments, the K×1 optical switches are all 4×1 type optical switches. In some embodiments, the 1×Nₒᵤₜ optical switches of the input array includes multiple levels of 1×2 optical switches arranged in a tree configuration and the Nᵢₙ×1 optical switches of the output array includes multiple levels of 2×1 optical switches arranged in a tree-like configuration. In some embodiments, an optical power loss of an optical beam traveling through the switch is substantially over different optical pathways between the optical input ports and optical output ports of the optical switch. In some embodiments, the plurality of optical crossconnect zones are passive optical components. In some embodiments, the crossconnect zones include one or more of collimators and mirrors. In some embodiments, the crossconnect zones include one or more planar waveguides located on one or more planar substrates. In some embodiments, the crossconnect zones include the planar waveguides located on one surface of a single planar substrate, and the coupling between the input and output waveguides in the crossconnect zones are implemented using waveguide bends located on the same planar substrate. In some embodiments, the crossconnect zones include the planar waveguides located on one surface of a single planar substrate, and the coupling between the input and output waveguides in the crossconnect zones are implemented using waveguide turning mirrors located on the same planar substrate. In some embodiments, the crossconnect zones are implemented with the planar waveguides located on two different surfaces of a single substrate, and the coupling between the input and output waveguides in the crossconnect zones are implemented using mirrors, optical vias, or waveguide proximity mirrors. In some embodiments, the crossconnect zones are implemented with the planar waveguides located on two different surfaces of two different substrates, and the coupling between the input and output waveguides in the crossconnect zones are implemented using mirrors, optical vias, or waveguide proximity mirrors.

Another embodiment is a method comprising manufacturing an optical switch manufacturing an optical switch having Nᵢₙ optical input ports and Nₒᵤₜ optical output ports. Manufacturing the optical switch includes forming an input array of 1×Nₒᵤₜ optical switches, forming an output array of Nᵢₙ×1 optical switches and forming a plurality of optical crossconnect zones located in-between the input array and the output array. Nᵢₙ and Nₒᵤₜ are integers greater than 1, and, each of Nᵢₙ*Nₒᵤₜ output waveguide arms of the 1×Nₒᵤₜ optical switches are optically coupled to a corresponding one of Nᵢₙ*Nₒᵤₜ input waveguide arms of the Nᵢₙ×1 optical switches.

In some embodiments, the input array, the output array and the plurality of optical crossconnect zones are formed concurrently. In some embodiments, the input array, the output array and the plurality of optical crossconnect zones are formed on a same substrate. In some embodiments, the input array is formed on a first substrate, the output array is formed on a second substrate and the plurality of optical crossconnect zones are formed on one or both of the first substrate and the second substrate.

### BRIEF DESCRIPTION OF THE DRAWINGS

The embodiments of the disclosure are best understood from the following detailed description, when read with the accompanying FIGUREs. Some features in the figures may be described as, for example, “top,” “bottom,” “vertical” or “lateral” for convenience in referring to those features. Such descriptions do not limit the orientation of such features with respect to the natural horizon or gravity. Various features may not be drawn to scale and may be arbitrarily increased or reduced in size for clarity of discussion. Reference is now made to the following descriptions taken in conjunction with the accompanying drawings, in which:

FIG. 1 presents a plan layout view of an example apparatus, including an optical switch of the disclosure;

FIG. 2 presents a three-dimensional perspective view of a portion of an example optical switch of the disclosure, analogous to the optical switch presented in FIG. 1 along view 2;

FIGS. 3A and 3B presents cross-sectional views of other example embodiments of an example optical switch of the disclosure, analogous to the optical switch presented in FIG. 1 along view line 3-3;

FIGS. 4A and 4B presents cross-sectional views of other example embodiments of an example optical switch of the disclosure, analogous to the optical switch presented in FIG. 1 along view line 3-3; and

FIG. 5 presents a flow diagram illustrating an example method that comprises manufacturing an optical switch of the disclosure, such as any of the optical switches discussed in the context of FIGS. 1-4.

### DETAILED DESCRIPTION

The description and drawings merely illustrate the examples of embodiments. It will thus be appreciated that those skilled in the art will be able to devise various arrangements that, although not explicitly described or shown herein, embody principles of the inventions and are included within their scope. Furthermore, all examples recited herein are principally intended expressly to be only for pedagogical purposes to aid the reader in understanding the principles of the inventions and the concepts contributed by the inventor(s) to furthering the arts, and are to be construed as being without limitation to such specifically recited examples and conditions. Moreover, all statements herein reciting principles, aspects, and embodiments of the inventions, as well as specific examples thereof, are intended to encompass equivalents thereof. Additionally, the term, “or,” as used herein, refers to a non-exclusive or, unless otherwise indicated. Also, the various embodiments described herein are not necessarily mutually exclusive, as some embodiments can be combined with one or more other embodiments to form new embodiments.

A general optical spatial switch can have N input ports and M output ports, and can route an optical beam from any of the input ports to any of the output ports, and is often termed as an N×M switch, where both N and M are integers. It is often desirable to have a high number of input and output port counts, i.e., large N and M values. In many situations, the number of input and output ports are equal and the switch is termed as an N×N switch. For instance, an 8×8 (N=8) switch or a 16×16 (N=16) switch. Some of the example embodiments described herein are directed to an N×N switch. Based on the present disclosure one skilled in the art would understand how switches could be designed for an N×M switch where M is also large but different than N.

For switches with large port counts, it is often desirable for each of the optical pathways from each input to output port to have a low optical power loss and a uniform power loss among the various possible pathways. The low power loss facilitates maintaining the optical signal strength and integrity, and the power loss uniformity facilitates reducing the route-related power fluctuation and dynamics that can degrade the performances of an optical system.

One conventional scheme of realizing an N×N switch is called a “crossbar” switch architecture, where a 2×2 switch element is used at each crossing node between one of the input ports and one of the output ports. In such architecture, the number of switch elements required is substantially proportional to N², i.e., when N is large. The number of switch elements in a particular optical pathway taken by an optical beam passing from an input port to an output port can vary from 1 to 2*N−1, i.e., for different routings. Since each switch element has some finite power loss, as N increases, the optical power loss of the worst pathways and also the power loss non-uniformity among all possible pathways from any input to any output increases. Although improved “crossbar” designs can eliminate the non-uniformity by having all possible pathways to have the same number of switch elements, i.e., all being the same to the worst pathways, the power loss is still typically undesirable. For instance, consider a 32×32 “crossbar” switch, the worst pathways go through 63 switch nodes. If each 2×2 switch node has 0.25 dB power loss (about 5%), the accumulated power loss will be 12.6 dB, or about 95%.

Embodiments of the present disclosure mitigate these problems and allow a uniform and low power loss for all possible pathways for large port count. The architecture uses an input network of 1×N optical switches, an output network of N×1 optical switches, and, low-loss optical crossconnect zones that couple the input network to the output network.

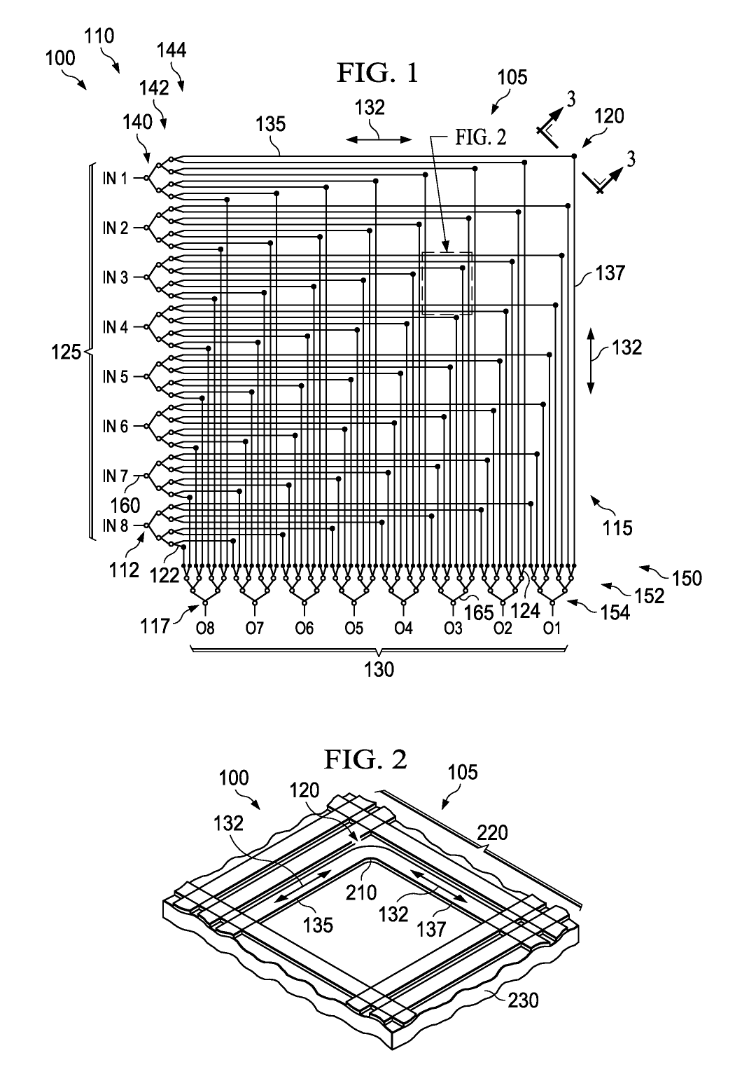

One embodiment is an apparatus. FIG. 1 presents layout diagram of an example embodiment of an apparatus 100 of the disclosure. Various embodiments of the apparatus include optical apparatus such as photonic integrated circuits (PIC), planer light wave circuit (PLC) platforms, and apparatus using free-space optical components. Embodiments of the apparatus 100 can be configured to operate in an optical communication system or an interconnection network, for example, interconnections within high-performance computers.

As illustrated in FIG. 1, the apparatus 100 comprises an optical switch 105. The optical switch 105 includes a tree-like input network 110 (also sometimes referred to as an input array herein) of 1×N optical switches 112 coupled to inputs In1 to In8, a tree-like output network 115 (also sometimes referred to as an output array herein) of N×1 optical switches 117 coupled to outputs O1 to O8, and a plurality of optical crossconnect zones 120 located in-between the tree-like input network 110 and the output network 115. While FIG. 1 shows input and output arrays of 8 switches 112, 117, other embodiments may have an input array of N switches and an output array of N switches where N is an integers greater than 1. Each one of the M output waveguide arms 122 of the 1×N optical switches 112 of the tree-like input network 110 are optically coupled to a unique one of the N input waveguide arms 124 of the N×1 optical switches 117 of the tree-like output network 115.

The terms 1×N optical switches and N×1 optical switches, as used herein, refer to any optical devices that can switch an optical signal from a single input into any one of multiple (N) outputs for a 1×N optical switch, or, in the reversed case, switch an optical signal from any one of multiple (N) inputs into a single output. A 1×N optical switch and N×1 optical switch can be the same device simply operating in opposite directions. In some cases the 1×N or N×1 switches can be have more than one input ports (for 1×N switches) or more than one output ports (for N×1 switches), but with only one of these ports used. The term tree-like network or array, as used herein, refers to multi-level tree-structure familiar to those skilled in the art. A tree-like network or array includes nodes and branches at each node. Typically, at each level of a multi-level tree the incoming branches split into multiple outgoing branches. In some cases the tree-like network or array can have multiple roots, e.g., multiple inputs In1-In8 for the input network or array and multiple outputs O1-O8 in the “inverted” tree-like output network or array.

As further illustrated in FIG. 1, for an N×N switch 105, the input network 110 contains a linear array of N copies of 1×N optical switch element 112. The input ports of all N copies of 1×N optical switch element comprise the N input ports 125 of the switch 105. Similarly, the output network 115 contains a linear array of N copies of N×1 optical switch element 117. The output ports of all N copies of N×1 optical switch element comprise the N output ports 130 of the switch 105.

The input network 110 has a total of N² output branches, as there are N copies of 1×N optical switch elements. Similarly, the output network 115 has a total of N² input branches, as there are N copies of N×1 optical switch elements. The N² output branches of the input network 110 are optically coupled to the N² input branches of the output network 115, with one-to-one correspondence, through the optical crossconnect zones 120.

In the input and output networks using only 1×N and N×1 switch elements, each having only one input or output port, simplifies the switch architecture. Each 1×N or N×1 element is independent from any other elements, and there is substantially no interconnection of optical pathways within the input or output network. In particular, optical interconnections between optical arms, e.g., interconnections between optical waveguide branches of the 1×N and N×1 switch elements 112, 117, are shown by enlarged filled-in dots in FIG. 1.

One of ordinary skill would understand how the switching configurations could be controlled by the input and output switch networks 110 and 115, and based on the present disclosure how, if desired, the optical crossconnect zones 120 could be configured to only provide passive optical connections and to not require dynamic reconfiguration during the switch operation.

One of ordinary skill would understand how the input and output switch arrays could be controlled in tandem such that an optical beam 132 from any one of the input ports In1-In8 could be sent to any one of the output ports O1-O8. For instance, if an optical signal at the m^{th} input port is to be routed to the k^{th} output port, then the m^{th} 1×N input switch (whose input port is connected to the m^{th} input port) is configured to send the signal to one of the N outputs that is optically connected through the optical crossconnect zones to the k^{th} N×1 output switch (whose output port is connected to the k^{th} output port). Similarly, the k^{th} N×1 output switch is connected to pick the signal from the input ports that is optically connected to the m^{th} 1×N input switch.

The absence of optical crosstalk, i.e., optical isolation, is a critical characteristic of an optical switch. In particular, the optical crosstalk measures the level of optical transmission from one input port In1-In8 to an output port O1-O8 that is different than the intended destination. In some cases, for example, an optical crosstalk of 40 dB or less is desired. This requires the switch elements in the switch to have a high level of optical isolation. For example, in some cross-bar switches, each switch node contains two stages of switches to enhance the optical isolation level. This doubles the number of switches required and also increases the power loss due to the extra switches. In the configuration depicted in FIG. 1, the optical signal is switched in both the input network 110 and the output network 115. Therefore, the effective optical isolation level is similar to a two-stage switch even if the input and output switch arrays use no extra switches. For instance, if the 1×N and N×1 switch elements have an optical isolation level of 20 dB or more, the combined optical isolation level of the device will be close to 40 dB or more.

For illustrative purposes, example embodiments described herein present configurations of an optical switch 105 having an equal number of input and output ports. However, based on the present disclosure, one of ordinary skill would understand that the disclosed embodiment include configurations where the input and output port counts are not equal. For instance, to construct an 8×10 switch, one can have 8 copies of a 1×10 optical switch in the input array, 10 copies of 8×1 optical switches in the output array, and optical crossconnect zones that connect the 80 output branches from the tree-like input network and the 80 input branches from the tree-like output network.

One of ordinary skill would understand that the optical switch 105 could be configured to operate in the inverse of the fashion as discussed herein. For instance, in an alternate the example embodiment as in FIG. 1 the ports In1-In8 could be output ports, and the ports O1-O8 input ports.

The 1×N or N×1 optical switch elements in each of the input and output arrays can be a single device that can route an optical signal between one port to any one of N ports. Examples of such device include configurable mirrors such as micromirrors based on conventional Micro-Electro-Mechanical-Systems (MEMS) technology. For a large N, such as 16, 32, or even higher, however, the switch element can be composed of multiple levels of smaller elements, for example, 1×2 or 2×1 optical switch elements, as depicted in FIG. 1. Examples of such smaller elements include planar photonic devices based on planar Mach Zehnder interferometers (MZIs).

The proposed switch architecture with multiple levels of smaller switch elements is advantageous for large port count compared to conventional crossbar switch architectures as it allows low and uniform power loss from any input port In1-In8 to any output port O1-O8. Often, for a port count of N, the 1×N and N×1 switch elements can be made of smaller, 1×K and K×1 switches, where K is an integer that is smaller than N, in a tree-configuration. The number of levels of such smaller optical switches is expected to grow as N becomes large as log_{K}N, and the total number of switch elements on each optical pathway from any input port to any output port is expected to be above 2*log_{K}N for large values of N. For example, for K=2, a 8×8 switch may have 3 levels of 1×2 switch elements in the input array and the output array, and each optical pathway contains 6 1×2 switch elements. For a 32×32 switch, each optical pathway may contain 10 1×2 switch elements. In comparison, in a conventional crossbar configuration the number of 2×2 switch elements in the optical pathways is expected to scale linearly with the port count N as 2*N−1 when N is large. For a 32×32 switch, the number of switch nodes in the optical pathways can be, e.g., as large as 63. If each switch node uses a double-stage switch to enhance the optical isolation level to be comparable to the architecture proposed here, the number of switch elements will be as large as 126. The reduction from 126 to 10 poses a considerable advantage in terms of optical power loss.

Since the tree-like input and output network comprise of 1×N or N×1 switches, all the smaller switch elements can be 1×K or K×1 switches, also with only one input or output port. The physical device can have more than one input port (for 1×K) or more than one output port (for K×1), as long as only one port is actively used.

In some embodiments, such as depicted in FIG. 1 the smaller 1×K switch elements are all 1×2 type optical switches. Using all 1×2 optical switches can have the advantage of simplifying the optical switch's fabrication, but this also typically involves the greatest number of levels of smaller optical switches in the input network 110 and output network 115. For instance for the 8×8 switch, with 8 input ports 125 and 8 output ports 130, as depicted in FIG. 1, there are three levels 140, 142, 144 of sequentially interconnected 1×2 optical switches 112 and three levels 150, 152, 154 of sequentially interconnected 2×1 output optical switches 117.

As further illustrated in FIG. 1, in some embodiments, the 1×N switch element 112 in the input optical network 110 can include a plurality of levels 140, 142, 144 of the 1×K optical switches (K=2 in FIG. 1). The 1 waveguide arm 160 of each of the 1×K optical switches is configured to receive an optical beam 132 from one of a plurality of input ports 125 or from a lower level (e.g., one of levels 150 or 152) of the 1×K optical switches. The K waveguide arms 122 of each of the 1×K optical switches can be configured to direct the optical beam 132 to one of the N outputs connected to the optical crossconnect zones 120 or to a higher level (e.g., one of levels 152 or 154) of the 1×K optical switches.

As also illustrated in FIG. 1, in some embodiments, the N×1 switch 117, the output optical network 115 includes a plurality of levels 150, 152, 154 of the K×1 optical switches. The K waveguide arms 124 of each of the K×1 optical switches can be configured to receive an optical beam 132 from the optical crossconnect zones 120 or from a higher level (e.g., levels 150 or 152) of the K×1 optical switches. The 1 waveguide arm of each of the K×1 optical switches can be configured to send the optical beam 132 to one of a plurality of output ports 130, or, to a lower level (e.g., levels 152 or 154) of the K×1 optical switches.

Based on the present disclosure, one of ordinary skill would understand how the number of levels 140, 142, 144 of 1×K optical switches in the input network 110 would depend upon the types of optical switches used (e.g., 1×2 optical switch versus 1×4 optical switch, etc. . . . ) and upon the number of input ports 125 and output ports 130 in the switch 105. Similarly, one of ordinary skill would understand how the number of levels of K×1 optical switches in the output network 115 would depend upon the types of optical switches used and the number of input ports 125 and output ports 130 in the switch 105.

For instance, in some embodiments, for a N×N switch, if all levels use the same type of 1×K or K×1 switches, then the number of levels needed in the input or output network would be expected to grow in a manner proportional to log_{K}N as N becomes large.

One of ordinary skill would understand that the 1×K switch elements do not have to be of all the same type. For example, one can have the first level to be of 1×2 type, the second level to be 1×3 type, and the third level to be 1×4 type, creating a combined 1×24 switch element with three levels. Since all 1×N elements in the input network and output network are independent from each other, one can also use different number of levels and different configurations for each 1×N element. One of ordinary skill would also understand that the 1×K or K×1 elements in different levels in different 1×N or N×1 elements could be made of different switches. For instances, some of these switches could be or include MEMS micromirrors, and some of these switches could be or include 1×2 integrated optical, MZI couplers.

Although all 1×N switches 112 in the input network 110 and all N×1 switches 117 in the output network 115 can have different arrangements of the 1×K or K×1 switch elements, in some embodiments, such as illustrated in FIG. 1, it is preferable to have similar arrangements among all 1×N switches in the input network and similar arrangements among all N×1 switches in the output network, so that all possible optical paths through the optical switch 105 travel through the same numbers of the same types of optical switches to ensure a uniform power loss.

For an N×N switch, the optical crossconnect zones 120 optically connect the N² output ports of the input network 110 and the N² input ports of the output network 115. The optical crossconnect zones can be implemented in many different ways. For example, the crossconnect zones can use optical waveguides to directly connect the N² pairs of ports in a one-to-one manner. The waveguides can be composed of any material used in guiding optical wavelengths of light, such as semiconductor materials like silicon, dielectric materials such as silica, silicon nitride, or polymers such as Poly(methyl methacrylate) (PMMA) and SU-8. In some cases, segments of the optical pathways can include or be defined in free space (e.g., air) and/or may use free space optical components such as collimators and mirrors.

In some embodiments of the switch 105, the plurality of optical crossconnect zones 120 includes, and in some cases the zones 120 are all, passive optical components. The term passive optical component, as used herein, refers an optical component that is configured to direct an optical beam 132 from the input network 110 to the output network 115, without being adjusted during the operation of the switch 105. In some cases, the use of passive components in the crossconnect zones has the advantages of reducing the complexity of the switch's fabrication as well and reducing the power requirements for the switch's operation.

In some cases, the passive optical components of the crossconnect zones 120 are fully passive, meaning that the optical components are not adjustable. For example, in some cases each of the passive optical components can be a waveguide or a fixed mirror. In other cases, however, the passive optical components of the crossconnect zones 120 can be adjusted, e.g., to fine tune optical transfer properties of the component. For example, each of the passive optical components can be an orientation-tunable micro mirror. Having a tunable optical component can facilitate minimizing the optical power losses through the crossconnect zones 120 and/or make the optical power losses throughout all of the zones 120 more uniform. In still other cases, however, the optical crossconnect zones 120 could include active optical components that are actively adjusted during the switch's operation.

FIG. 2 presents a three-dimensional perspective view of a portion of an example optical switch 105 in FIG. 1 along view 2.

FIG. 2 illustrates the implementation of one of the crossconnect zones 120 using planar waveguides. For instance, input waveguides 135 (shown with horizontal orientation) are connected to the input network 110 to the left, and output waveguides 137 (shown with vertical orientation) are connected to the output network to the bottom. The optical signal is directed from one of the input waveguides 135 to one of the output waveguides 137 only when said waveguides 135, 137 are directly connected through a coupler 210 such as a bend or a turning mirror. In the case of perpendicular waveguide crossings, the optical signal maintains its propagation direction, as indicated by the arrows 132, i.e., without significantly coupling into the waveguide crossed. Such embodiments have an advantage of being compact and simple to construct. In such embodiments, the optical waveguide crossings are typically constructed to provide, at most, low the optical power losses.

In some cases, the input waveguides 135, the output waveguides 137, and the couplers 210 are all implemented using a single waveguide layer on the same planar surface. Each of the in-plane couplers 210 can be a curved waveguide bend as depicted in FIG. 2, a turning mirror, or another conventional optical structure typically used to couple light between two waveguides. In some other cases, the input waveguides 135 and the output waveguides 137 are implemented on two different planes on a single planar substrate, or on two different planar substrates. The couplers 210 may be implemented with structures that couple light between waveguides on two different planes, such as proximity directional couplers, optical vias, turning mirrors, etc. This approach can reduce the optical power loss and crosstalk at optical waveguide crossings. That is, the waveguides of such embodiments can be vertically separated to not physically cross each other.

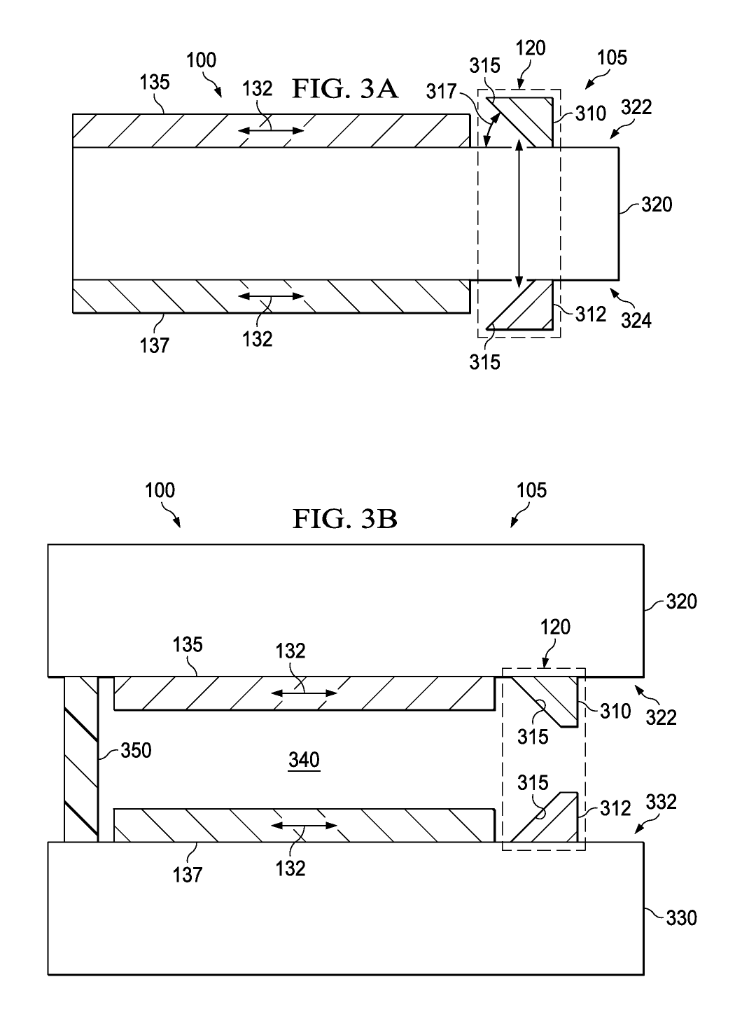

FIGS. 3A and 3B present cross-sectional views of other example embodiments of an example optical switch of FIG. 1 along view line 3-3.

As illustrated in FIG. 3A, in some embodiments, one or more of the crossconnect zones 120 includes one or more optical mirrors 310, 312. The optical mirror 310 or mirrors 310, 312 are configured to direct an optical beam 132 between the input network 110 and the output network 115. For instance each mirror 310, 312 can have a reflective surface 315 configured to be oriented at an angle 317 (e.g., an about 45 degree angle in some case) so as to direct the optical beam 132 traveling from the input network 110 to the output network 115. In some cases, the mirror 310 or mirrors 310, 312 can be passive mirrors that cannot be adjusted. In other cases, the mirror 310 or mirrors 310, 312 can be coupled to a micromechanical device configured to adjust the position or orientation of the mirror (e.g., the angle of the reflective surface 315) so as to maximize the transfer of an optical beam 132 traveling through the crossconnect zones from the input network 110 to the output network 115.

As illustrated in FIG. 3A in some embodiments of the switch 105, the first mirror 310 and input network 110 and in some cases, the input waveguides 135 can be located on a substrate 320 have a planar surface 322 and the second mirror 312 and output network 115, and in some cases, the output waveguides 137 can be located on an opposite planar surface 324 of the substrate 320. The reflective surfaces 315 of the mirrors 310, 312 can be configured to reflect an optical beam 132 from one mirror 310 to another mirror 312 through the substrate 320.

Other embodiments of the switch 105 which include two substrates can also advantageously decrease optical losses and crosstalk at waveguide crossing points. For instance, as illustrated in FIG. 3B, the input waveguides 135, optically coupled to the input network 110 of optical switches 112, can be located on a first substrate 320 (e.g., located on a planar surface 322 of the substrate 320), and output waveguides 137, optically coupled to the output network 115 of optical switches 117, can be located on a second substrate 330 (e.g., located on a planar surface 322 of the substrate 330). Each one of the crossconnect zones 120 includes one or more optical mirrors 310, 312 configured to direct the optical beam 132 between the input waveguides 135 and the output waveguides 137.

As illustrated in FIG. 3B, in some cases, the transfer can occur through a free-space 340 between the first substrate 320 and the second substrate 330. For instance, an optical beam 132 can reflect off a first mirror 310 that is located on the first substrate 320 and then travel through the free-space 340 to a second mirror 312 located on the second substrate. For example, the first mirror 310 can be configured to receive the optical beam 132 from the input waveguide 135, and the second mirror 312 can be configured to receive the optical beam 132 from the first mirror 310 and reflect the optical beam 132 towards one of the output waveguides 137. The input waveguide 135 and each output waveguide 137 can be configured to not intersect with any other waveguides 135, 137 thereby reducing or eliminating the possibility of optical losses and crosstalk at crossover points between waveguide 123, 137.

In other cases, however, redirection of the optical beam 132 can occur through the first substrate 320 and second substrate 330 with no free-space in-between the substrates 320, 330. For instance, the reflective surface 315 of the first mirror 310 can be configured to reflect the optical beam 132 from the input waveguide 135 through the first substrate 320 to the adjacently located second substrate 330, and light of the optical beam 132 can travel through the second substrate 330 to the reflective surface 315 of the second mirror 312, the second mirror being configured receive the optical beam 132 traveling through the second substrate 330. Such embodiments can advantageously provide more compact and mechanically resilient embodiments of the switch 105, because the free-space 340 between the two substrates 320, 330 does not have to be maintained.

In some embodiments, the mirrors in FIG. 3B can be replaced with proximity waveguide couplers such as directional couplers. For example, it can have two waveguide pieces that are continuous with the input and output waveguides 135 and 137, respectively, and the optical signal can be transferred from one of two waveguide pieces to the other.

In some embodiment, the two layers shown in FIG. 3B can be located on a single substrate but vertically separated. The coupling between the input waveguides 135 and the output waveguides 137 can be implemented using mirrors similar to FIG. 3B or other structures such as the proximity waveguide couplers described above.

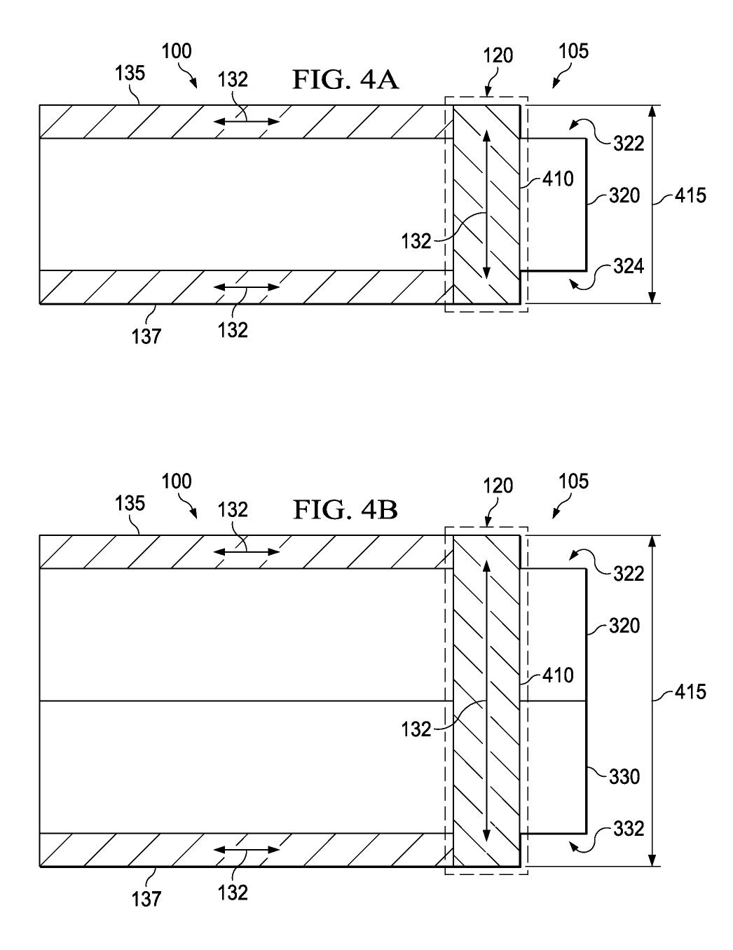

FIGS. 4A and 4B present a cross-sectional views of other example embodiments of another example optical switches 105 of the disclosure, analogous to the optical switch 105 presented in FIG. 1 along view line 3-3.

As illustrated in FIGS. 4A and 4B, in some embodiments, at least one, and in some cases each one, of the crossconnect zones 120 includes an optical via 410 configured to optically couple an optical beam 132 between the input network 110 and the output network 115 (FIG. 1).

As illustrated in FIG. 4A in some embodiments of the switch 105, the input network 110 and in some cases, the input waveguides 135 can be located on a substrate 320 have a planar surface 322. In some embodiments, the output network 115, and in some cases, the output waveguides 137 can be located on an opposite planar surface 324 of the substrate 320. The optical via 410 can be configured to pass through the substrate to thereby optically couple the input network 110 and the output network 115. Such a configuration can help avoid having different amounts of optical losses when different optical pathways cross a different number of waveguides.

As illustrated in FIG. 4B in other embodiments of the switch 105, the optical via 410 can be optically coupled to the input waveguide 135 on the first substrate 320 and optically coupled to the output waveguide 137 on the second substrate 330. In some cases, the optical via 410 can include, or in some cases be, a separate waveguide layer. In some cases, the optical via can be continuous with one or both of the input waveguide 135 or output waveguide 137. In some cases, a light-transfer dimension 415 of the optical via 410 can be substantially perpendicular with respect the planar surfaces 322, 332 of the first and/or second substrate 320, 330, respectively. For instance, in same cases, the optical via 410 can include or be an out-of-plane bend in one or both of the input waveguide 135 or output waveguide 137.

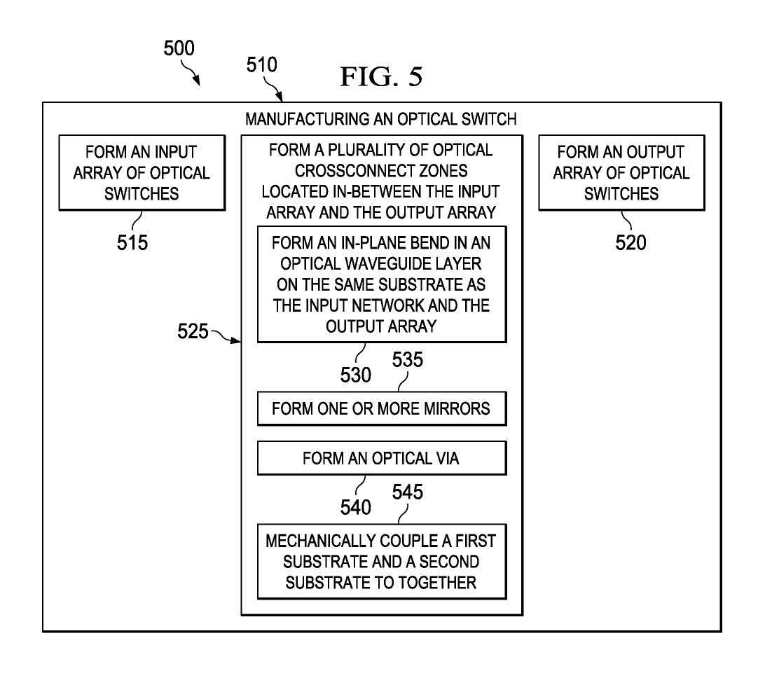

FIG. 5 presents a flow diagram illustrating an example method 500 that comprises a step 510 of manufacturing an optical switch, such as any of the optical switches 105 discussed in the context of FIGS. 1-4. With continuing reference to FIGS. 1-4, manufacturing the optical switch (step 510), includes a step 515 of forming an input network 110 (or array) of 1×N optical switches 112, a step 520 of forming an output network 115 (or array) of N×1 optical switches 117 and a step 525 of forming a plurality of optical crossconnect zones 120 located in-between the input network 110 (or array) and the output network 115 (or array). As noted in the context of FIG. 1, N is an integer greater than 1, and, each one of the N² waveguide arm outputs 122 of the input network 110 are optically coupled to a unique one of the N² waveguide arm inputs 124 of the output network 115. In various embodiments, the steps 515, 520, and 525 may be performed concurrently or sequentially.

In some embodiments, such as illustrated in FIG. 2, the input network 110, the output network 115, and the crossconnect zones 120 are formed on a same substrate 230. One of ordinary skill in the art would be familiar with the procedures to make optical switches 112, 117 and the input/output networks 110 and 115 on the substrate 230 using standard photolithography procedures for integrated planar photonic circuits. Alternatively, one skilled in the art would understand how to mount pre-manufactured output switches 112, 117 on the substrate 230, e.g., using micromanipulators, to form the input and output networks 110, 115 as part of steps 510 and 515, respectively.

Similarly, one of ordinary skill would understand how to use standard photolithography procedures to form a crossconnect zones 120 that includes a step 530 of forming an in-plane bend 210 in an optical waveguide layer 220 located on the substrate 230, as part of step 520, wherein in-plane bend 210 is configured to transfer an optical beam 132 between the input network 110, located on the substrate 230, and the output network 115, also located on the substrate 230.

Similar procedures could be adopted to form input and output waveguides 135, 137 on the substrate 230 to facilitate coupling the input network 110 to the output network 115 through the crossconnect zones 120.

In some embodiments, such as illustrated in FIG. 3 or 4, it is desirable to manufacture an optical switch 105 such that each optical pathway from the input network 110 to the output network 115 does not intersect with any other optical pathway from the input network 110 to the output network 115. For instance, as part of step 510 the input network 110 can formed on a first substrate 320, and the output network, as part of step 515 can be formed on a second substrate 330 and the plurality of optical crossconnect zones 120, as part of step 520, can be formed on one or both of the first and second substrates 320, 330.

In some cases, forming the crossconnect zones 120 (step 520) includes providing one or more mirrors 310, 312 in step 535, the one or more mirrors 310, 312 are configured to reflect an optical beam 132 between the input network 110 and the output network 115. In some embodiments, for example, each mirror can be provided by a forming step that includes etching a material layer on the substrate 310, or substrates 310, 312 through a dry etch with masks (for instance, grayscale photolithography and etch) or a non-isotropic wet etch of a material layer with a particular crystal orientation to form the reflective surface 315 with the desired angle 317 to facilitate transferring the optical beam.

In some cases, forming the crossconnect zones 120 (step 520) includes forming an optical via 410 in step 540, the optical via 410 configured to transfer an optical beam 132 between the input network 110 and the output network 115. One skilled in the art would be familiar with conventional patterning, etching and deposition procedures to form an out-of plane waveguide layer, e.g., whose light-transfer dimension 415 is oriented substantially perpendicular to a planer surfaces 322, 332 of one or both of the substrates 320, 330.

Some embodiments of the method 500 as past of forming the crossconnect zones (step 525) can further include a step 545 of mechanically coupling the first substrate 320 (e.g., having the input network 110 thereon) and second substrate 330 (e.g., having the output network 115 there on) together. One skilled in the art would be familiar with the various procedures that could be used to mechanically coupling the first substrate 320 and second substrate 330 together using. e.g., clamps, adhesives or similar methods. In some cases, as part of the coupling step 540, a standoff structure 350 can be mounted on one or both of the substrates 320, 330 to provide a free-space 340 between the first and second substrates 320, 330. In other cases the first substrate 320 and second substrate 330 can be coupled directly together with no free space in-between.

Some embodiments of the method 500, as past of forming the crossconnect zones (step 525), can use optical waveguides such as fibers to directly connect the output ports of the input network 110 and the input ports of the output network 115.

Some embodiments of the method 500 as past of forming the crossconnect zones (step 525) can use free-space optical pathways and components such as mirrors and collimators to connect the output ports of the input network 110 and the input ports of the output network 115.

Although the present invention has been described in detail, those skilled in the art should understand that they can make various changes, substitutions and alterations herein without departing from the scope of the invention.

What is claimed is:

1. An apparatus, comprising:
an optical switch having Nᵢₙ optical input ports and Nₒᵤₜ optical output ports, including:
an input array of 1×Nₒᵤₜ optical switches;
an output array of Nᵢₙ×1 optical switches; and
a plurality of optical crossconnect zones located in-between the input array and the output array, wherein Nᵢₙ and Nₒᵤₜ are integers greater than 1, and, each of Nᵢₙ*Nₒᵤₜ output waveguide arms of the 1×Nₒᵤₜ optical switches are optically coupled to a corresponding one of Nᵢₙ*Nₒᵤₜ input waveguide arms of the Nᵢₙ×1 optical switches.

2. The apparatus of claim 1, wherein each 1×Nₒᵤₜ optical switch of the input array includes multiple levels of 1×K optical switches connected in a tree-like configuration.

3. The apparatus of claim 2, wherein the 1×K optical switches are 1×2 type optical switches.

4. The apparatus of claim 2, wherein the 1×K optical switches are 1×4 type optical switches.

5. The apparatus of claim 1, wherein each Nᵢₙ×1 optical switch of the output array includes multiple levels of K×1 optical switches arranged in a tree-like configuration.

6. The apparatus of claim 5, wherein the K×1 optical switches are 2×1 type optical switches.

7. The apparatus of claim 5, wherein the K×1 optical switches are all 4×1 type optical switches.

8. The apparatus of claim 1, wherein the 1×Nₒᵤₜ optical switches of the input array includes multiple levels of 1×2 optical switches arranged in a tree configuration and the Nᵢₙ×1 optical switches of the output array includes multiple levels of 2×1 optical switches arranged in a tree-like configuration.

9. The apparatus of claim 1, wherein an optical power loss of an optical beam traveling through the switch is substantially over different optical pathways between the optical input ports and optical output ports of the optical switch.

10. The apparatus of claim 1, wherein the plurality of optical crossconnect zones are passive optical components.

11. The apparatus of claim 1, wherein the crossconnect zones include one or more of collimators and mirrors.

12. The apparatus of claim 1, wherein the crossconnect zones include one or more planar waveguides located on one or more planar substrates.

13. The apparatus of claim 12, wherein the crossconnect zones include the planar waveguides located on one surface of a single planar substrate, and the coupling between the input and output waveguides in the crossconnect zones are implemented using waveguide bends located on the same planar substrate.

14. The apparatus of claim 12, wherein the crossconnect zones include the planar waveguides located on one surface of a single planar substrate, and the coupling between the input and output waveguides in the crossconnect zones are implemented using waveguide turning mirrors located on the same planar substrate.

15. The apparatus of claim 12, wherein the crossconnect zones are implemented with the planar waveguides located on two different surfaces of a single substrate, and the coupling between the input and output waveguides in the crossconnect zones are implemented using mirrors, optical vias, or waveguide proximity mirrors.

16. The apparatus of claim 12, wherein the crossconnect zones are implemented with the planar waveguides located on two different surfaces of two different substrates, and the coupling between the input and output waveguides in the crossconnect zones are implemented using mirrors, optical vias, or waveguide proximity mirrors.

17. A method, comprising:
manufacturing an optical switch having Nᵢₙ optical input ports and Nₒᵤₜ optical output ports, including:
forming an input array of 1×Nₒᵤₜ optical switches;
forming an output array of Nᵢₙ×1 optical switches; and
forming a plurality of optical crossconnect zones located in-between the input array and the output array, wherein Nᵢₙ and Nₒᵤₜ are integers greater than 1, and, each of Nᵢₙ*Nₒᵤₜ output waveguide arms of the 1×Nₒᵤₜ optical switches are optically coupled to a corresponding one of Nᵢₙ*Nₒᵤₜ input waveguide arms of the Nᵢₙ×1 optical switches.

18. The method of claim 17, wherein the input array, the output array and the plurality of optical crossconnect zones are formed concurrently.

19. The method of claim 17, wherein the input array, the output array and the plurality of optical crossconnect zones are formed on a same substrate.

20. The method of claim 17, wherein the input array is formed on a first substrate, the output array is formed on a second substrate and the plurality of optical crossconnect zones are formed on one or both of the first substrate and the second substrate.
